(19) United States
(12) Patent Application Publication
(10) Pub. No.: US 2022/0194240 A1
(43) Pub. Date: Jun. 23, 2022

(54) CHARGING SYSTEM OF VERTICAL ROTARY TYPE PARKING APPARATUS

(71) Applicant: Dal Young PARK, Seoul (KR)

(72) Inventor: Dal Young PARK, Seoul (KR)

(21) Appl. No.: 17/689,972

(22) Filed: Mar. 8, 2022

(51) Int. Cl. B60L 53/30; E04H 6/14; E04H 6/42

(52) U.S. Cl. CPC B60L 53/30; E04H 6/42; E04H 6/14

(57) ABSTRACT

Provided is a charging system of a vertical rotary type parking apparatus, and more particularly, to a charging system of a vertical rotary type parking apparatus in which linear busbars through which power is supplied are mounted on the left and right frames of the parking apparatus, and a collector that is slidably coupled with the busbars for receiving electricity and a charger are mounted in each pallet on which a vehicle is loaded, thereby charging electric vehicles during parking.

### TECHNICAL FIELD

The present invention relates to a charging system of a vertical rotary type parking apparatus, and more particularly, to a charging system of a vertical rotary type parking apparatus in which linear busbars through which power is supplied are mounted on the left and right frames of the parking apparatus, and a collector that is slidably coupled with the busbars for receiving electricity and a charger are mounted in each pallet on which a electric vehicle is loaded, thereby charging electric vehicles during parking.

### RELATED ART

Due to an increase in electric vehicles, an electric vehicle charging system is required for vertical rotary type parking apparatuses. Accordingly, charging system technology for vertical rotary type parking apparatuses has been developed. However, as the apparatus is complicated and has low safety, a charging system that has a more concise structure and is safer and more easily adoptable is to be provided.

As an example, a charging system of a vertical rotary type parking apparatus by the present inventor is disclosed in International Publication No. WO 2020/009257A1, which is illustrated in FIGS. 1 to 4B.

Referring to FIG. 3, in a curved section of a busbar 180, a sliding state of a collector 200 is not smooth so that the collector 200 may be derailed.

Furthermore, in the curved section, there is a risk of a short-circuit accident because mineral or metallic foreign materials tend to accumulate.

Furthermore, referring to FIGS. 4A and 4B, a power receiving apparatus of a hanger pipe 171 at an upper side of a pallet 160 includes a hollow non-conductive first fixed body 173, a non-conductive second fixed body 174, a first ring member 175, and a second ring member 176, which correspond to a kind of a slip ring, and receives electricity while pivoting, and thus, the structure thereof is complicated, the manufacturing cost is high, and there is a risk of current leakage or short circuit when the production quality is incomplete.

Furthermore, when the above charging apparatus is installed on already built vertical rotary type parking apparatuses, the structures of a pallet holder 150 and the hanger pipe 171 cannot be used as they are, and thus, the pallet holder 150 and the hanger pipe 171 need to be removed and replaced with newly manufactured components so that the manufacturing cost rises and installation is complicated.

Furthermore, in order to simultaneously charge multiple vehicles, the busbar 180 having a large capacity is to be installed, and it may be difficult to take the busbar 180 because there is no sufficient space in an inner space of the pallet holder 150 of a vertical rotary type parking apparatus to take the busbar 180 that is relatively large therein. As the capacity of the busbar 180 is large, the manufacturing cost increases, and as a high current is supplied, there is a disadvantage in safety.

### DISCLOSURE OF THE INVENTION

### Technical Goal of the Invention

The present invention provides a charging system of a vertical rotary type parking apparatus that is easily installed in already built vertical rotary type parking apparatuses without modification of the apparatus.

Also, the present invention provides a charging system of a vertical rotary type parking apparatus that is safe while having a simple structure and being inexpensive.

Means for Achieving Technical Goal

According to the present invention, a charging system of a vertical rotary type parking apparatus includes:
a pair of frames arranged apart from each other;
a rail having a track shape, fixed on each of the pair of frames, and including a curved section disposed at each of upper and lower sides and a linear section disposed at each of left and right sides;
a pair of main chains, each being movably coupled to the rail and circulating and rotating by power of a motor;
a plurality of pallet holders, each having one end portion being fixed on each of the main chains facing each other at regular intervals;
a hanger including a pivot shaft having both end portions pivotably connected to the plurality of pallet holders facing each other, a pair of horizontal bars, each having a center portion fixed on both end portions of the pivot shaft, a pallet on which a vehicle is loaded, and an arm pipe connecting the pair of horizontal bars to the pallet so that the pallet maintains a horizontal state;
a pair of busbars, through each of which power is supplied, fixed on the frames corresponding to the linear section of the rail, and asymmetrically arranged in left and right sides with respect to a center portion of the rail;
a distribution panel configured to supply power by connecting a power cable to each of the busbars;
a collector mounted on the horizontal bars apart from the pivot shaft by a certain distance, and sliding along the busbars; and
a charger mounted on the hanger and receiving power from the collector for charging electricity, wherein a vehicle loaded on the pallet is charged by the charger.

Furthermore, in the charging system according to the present invention, an upper trumpet tube may be provided on an upper end of each of the pair of busbars and a lower trumpet tube may be provided on a lower end thereof, and

the collector includes a guide roller guided by the upper trumpet tube and the lower trumpet tube, and a carbon brush sliding on each of the pair of busbars.

Furthermore, in the charging system according to the present invention, each of the pair of busbars includes a non-conductive casing having one open side, and at least a pair of copper plates arranged apart from each other in the casing and through which power is supplied and slidably coupled with the carbon brush, so that electricity is supplied in parallel.

### Effect of the Invention

First, the charging system according to the present invention has an effect in that, as the collector 30 is fixed at an eccentric position of the hanger 19, the busbars 20a and 20b of a linear type are fixed to the frame 10, the charging system may be simply installed on already built vertical rotary type parking apparatuses without modification of the apparatus.

Second, the charging system according to the present invention has an effect in that, as the collector 30 is mounted on the horizontal bar 18 apart from the pivot shaft 15 of the hanger 19 by a certain distance, and the busbars 20a and 20b are arranged asymmetrically in the left and right sides, a pivot collection element like a slip ring may not be required for performing safe electricity feeding.

Third, the charging system according to the present invention has an effect in that, as the upper trumpet tube 24 and the lower trumpet tube 25 are provided at the upper and lower entrance portions of the busbars 20a and 20b, the collector 30 may smoothly enter and derailment thereof may be prevented.

Fourth, the charging system according to the present invention has an effect in that, as the non-conductive casing 23 is provided, electric shock or short-circuit accidents may be prevented.

Fifth, as the busbars 20a and 20b are divided into several sections and electricity is supplied in parallel for each section, the busbars 20a and 20b that are small may be used, which enables easy installation and provides an economical effect.

### BRIEF DESCRIPTION OF THE DRAWINGS

FIG. 1 is a perspective view of a vertical rotary type parking apparatus employing a charging system according to the related art.

FIG. 2 is an excerpted perspective view of a vehicle charging portion of FIG. 1.

FIG. 3 is an excerpted perspective view of the electricity receiving portion of FIG. 1.

FIG. 4A is a side view showing a major portion of FIG. 2.

FIG. 4B is an enlarged view of a region A of FIG. 4A.

FIG. 5 is a perspective view of a vertical rotary type parking apparatus before a charging system according to the present invention is installed thereon.

FIG. 6A is a perspective view of the parking apparatus of FIG. 5 in which the charging system according to the present invention is installed.

FIG. 6B is an excerpted perspective view of a region of FIG. 6A.

FIG. 7 is an excerpted view of a major portion of FIG. 6A, showing a charging state of a vehicle.

FIG. 8 is a view for explaining the operations of a busbar and a collector.

FIG. 9A is a front view of FIG. 6A.

FIG. 9B is a partially enlarged view of FIG. 9A.

FIG. 9C is a view showing a parallel power supply.

FIG. 10 is a cross-sectional view taken along line A-A of FIG. 9A.

FIG. 11 is a cross-sectional view taken along line B-B of FIG. 9A.

FIG. 12 is a cross-sectional view taken along line C-C of FIG. 9A.

FIG. 13A is an enlarged view of a region Q of FIG. 10.

FIG. 13B is an enlarged view of a major portion of FIG. 13A.

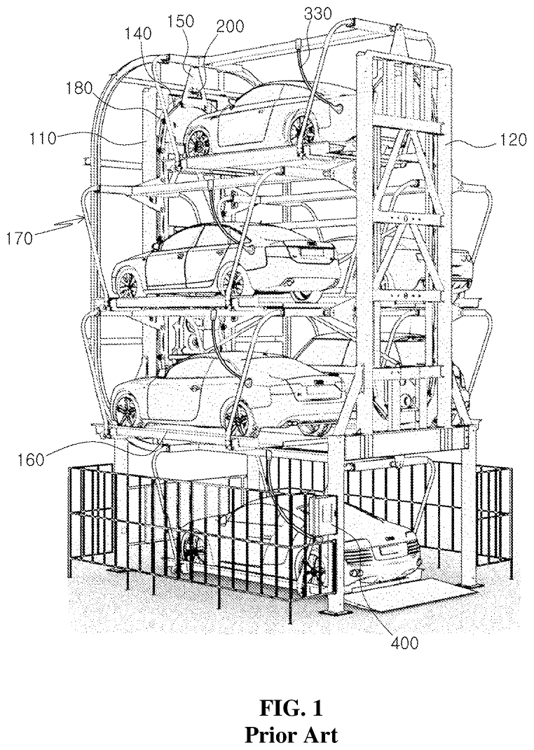

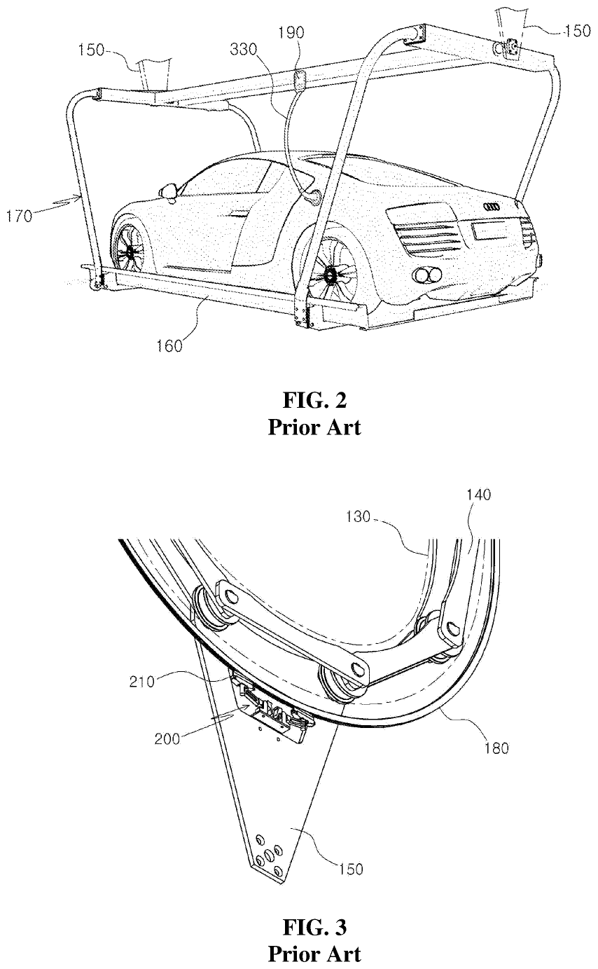

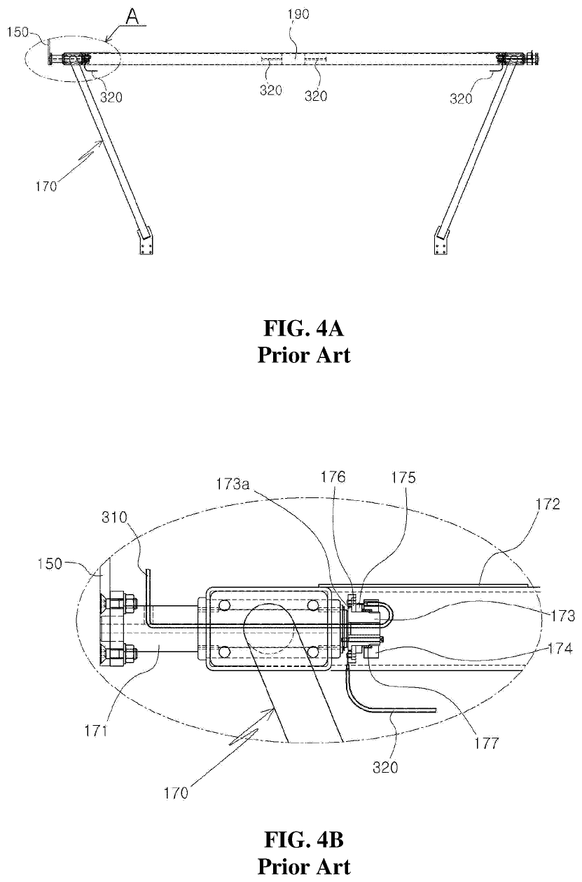

### DESCRIPTION OF EMBODIMENT

According to a charging system of a vertical rotary type parking apparatus according to an embodiment of the present invention, as linear busbars through which power is supplied are mounted on the left and right frames of the parking apparatus, and a collector that is slidably coupled with the busbars for receiving electricity and a charger are mounted in each hanger on which a vehicle is loaded, electric vehicles may be charged during parking.

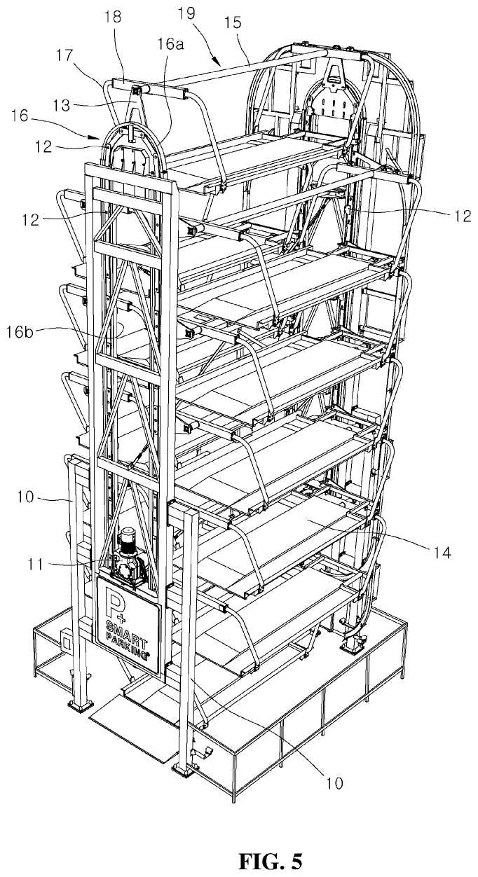

A vertical rotary type parking apparatus in which the charging system according to an embodiment of the present invention is not installed, referring to FIG. 5, includes: a pair of frames 10 arranged apart from each other; a rail 16 having a track shape that is fixed on each of the frames 10 and includes a curved section 16a disposed at each of upper and lower sides and a linear section 16b disposed at each of left and right sides; a pair of main chains 12 that are movably coupled to each of the rail 16 and circulated and rotated by power of a motor 11; a plurality of pallet holders 13, each having one end portion being fixed on each of the main chains 12 facing each other at regular intervals; and a hanger 19 that is pivotably connected to each of the pallet holders 13 and on which a vehicle is loaded.

The hanger 19 includes a pivot shaft 15 having both end portions rotatably connected to the pallet holders 13 facing each other, a pair of horizontal bars 18, center portions of the horizontal bars 18 being fixed on both end portions of the pivot shaft 15, a pallet 14 on which a vehicle is loaded, and an arm pipe 17 connecting the horizontal bars 18 to the pallet 14 so that the pallet 14 maintains a horizontal state.

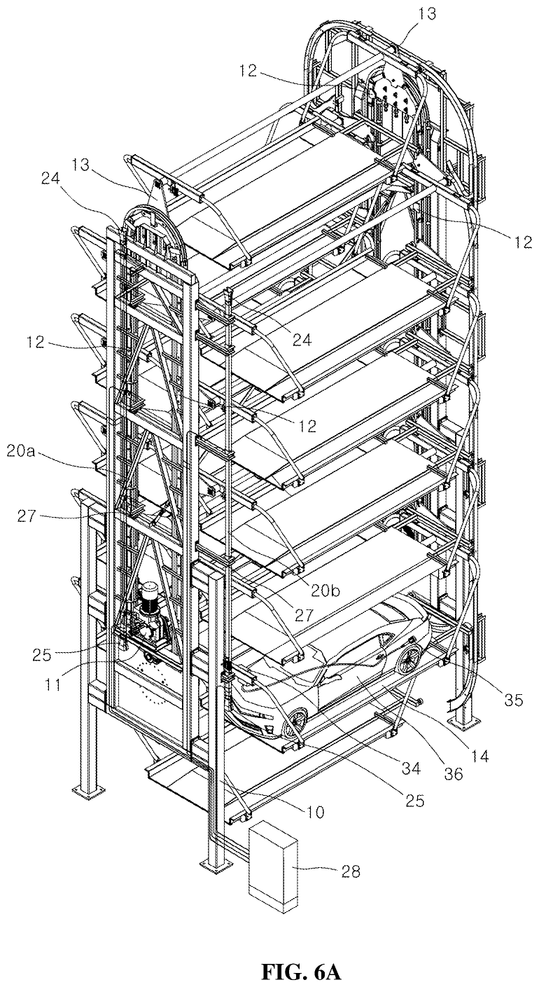

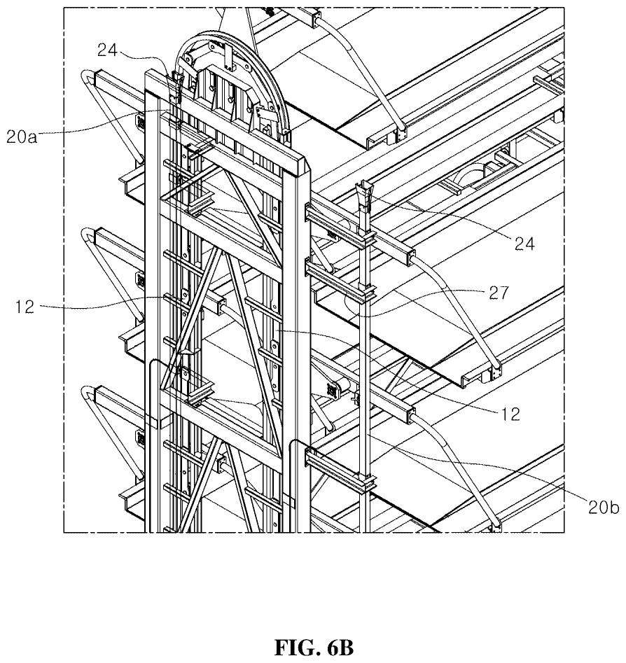

FIGS. 6A and 6B show a state of the parking apparatus of FIG. 5 in which the charging system according to an embodiment of the present invention is installed.

The charging system according to an embodiment of the present invention includes busbars 20a and 20b fixed on the frames 10 and through which power is supplied, a collector 30 that is eccentrically arranged on the horizontal bars 18 of the hanger 19 and sliding along the busbars 20a and 20b and a charger 34 for charging electricity, and a distribution panel 28 that supplies power by connecting a power cable to each of the busbars 20a and 20b.

The charging system according to an embodiment of the present invention, as illustrated in FIG. 6A, may perform charging through a charging cable 35 while an electric vehicle 36 is parked on the pallet 14.

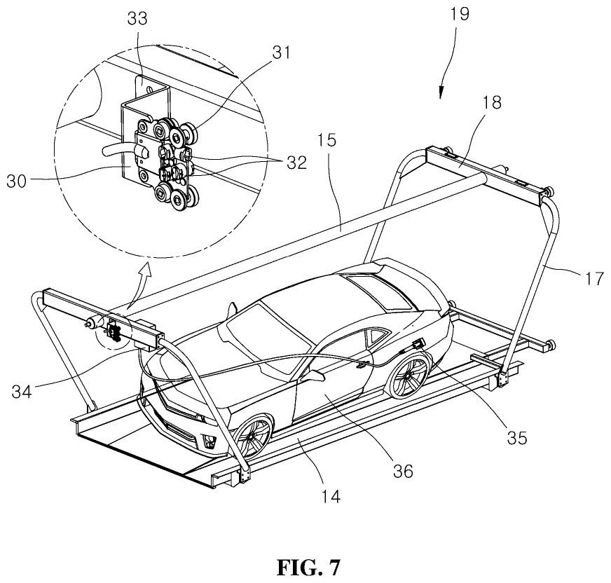

Referring to FIGS. 7, 9B, and 13A, the collector 30 is mounted on the horizontal bars 18 by means of a bracket 33 to be apart from the pivot shaft 15 by a certain distance.

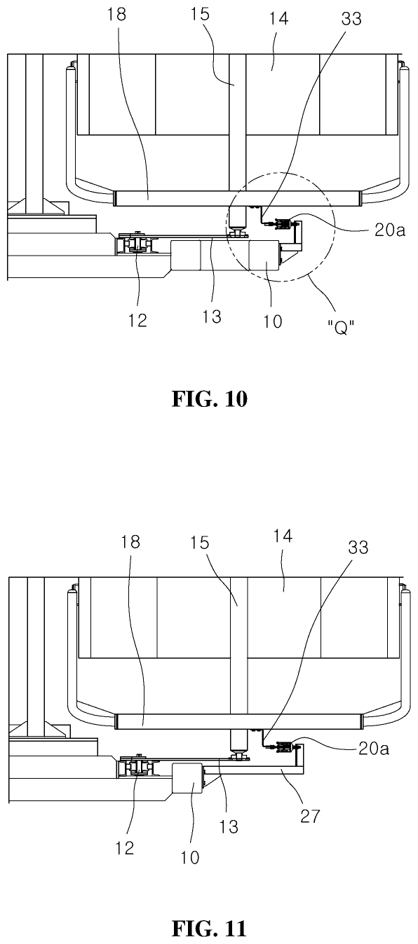

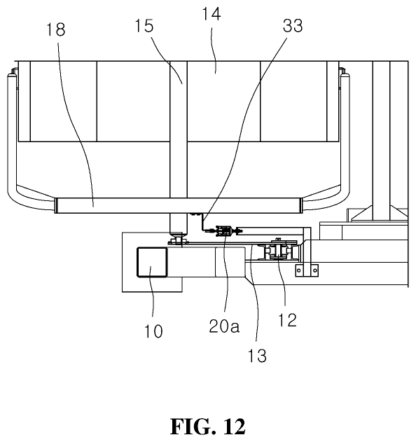

For example, as in the related art, when the collector 30 according to an embodiment of the present invention is mounted on the pivot shaft 15 that is a pivot center of the hanger 19, the structure thereof is complicated and a pivot collection element like a slip ring that is expensive is required, but in the present invention, as illustrated in FIGS. 10 to 12, the collector 30 is mounted on the horizontal bars 18 to be apart from the pivot shaft 15 by a certain distance, and thus, a pivot collection element like a slip ring is not required for performing safe electricity feeding.

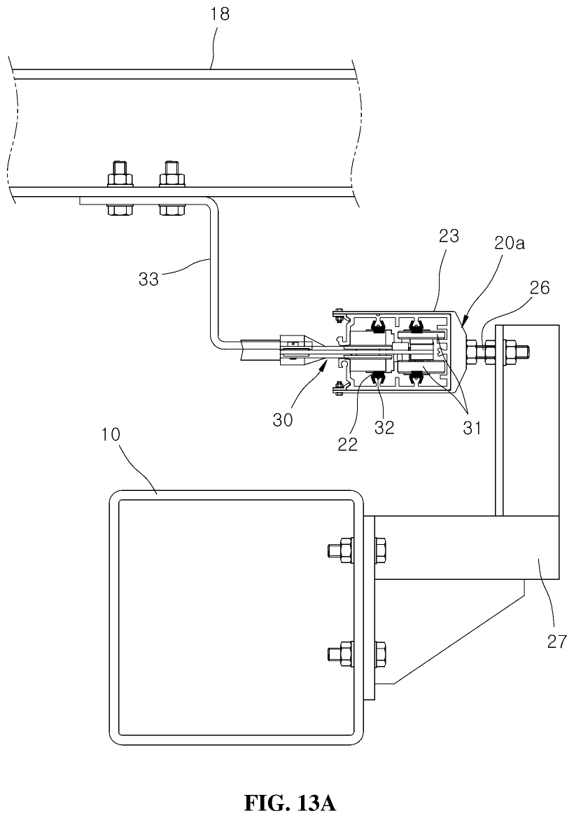

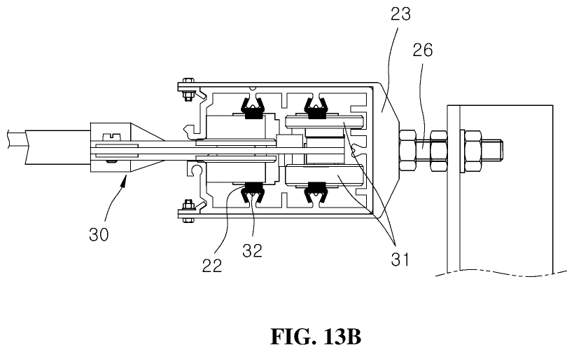

Referring to FIGS. 6B and 13A, the busbars 20a and 20b are fixed on the frames 10 corresponding to the linear section 16b of the rail 16 by means of a plurality of fixing brackets 27 and a fixing device 26.

Each of the fixing brackets 27 may be simply fixed to the frames 10 by bolting, and may be simply mounted by bolting each of the busbars 20a and 20b by using the fixing device 26.

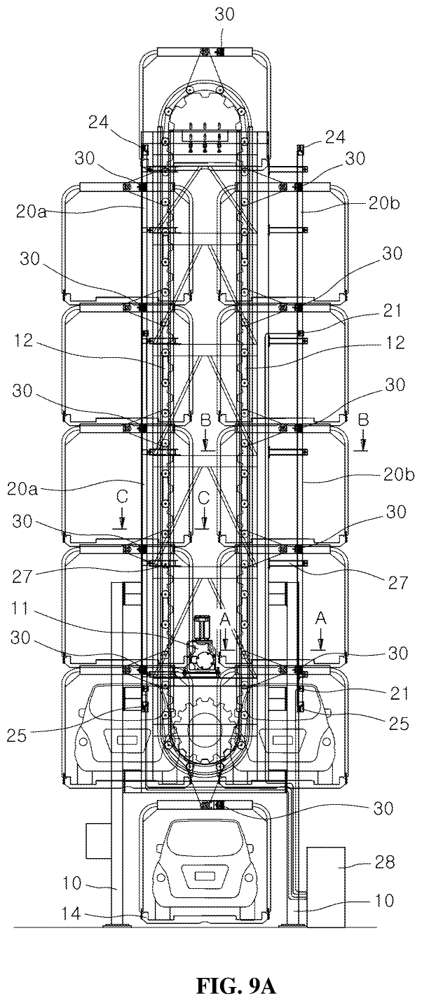

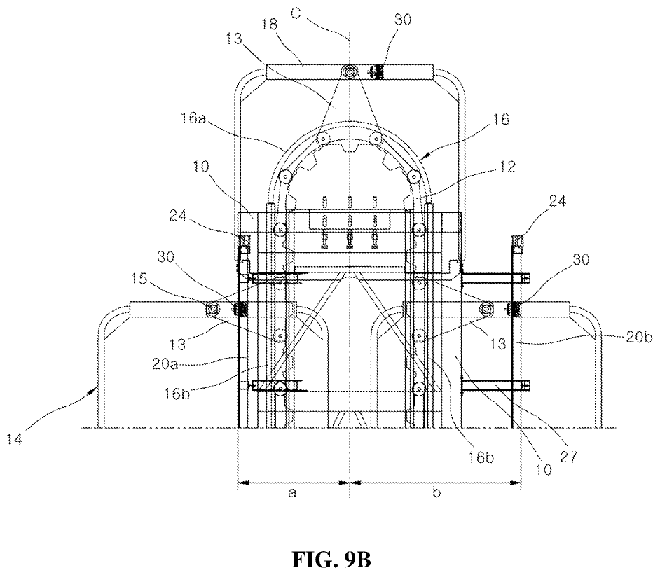

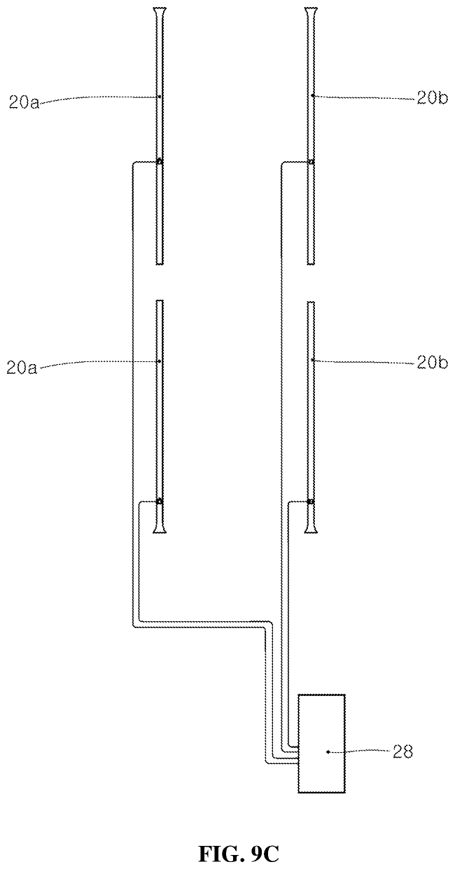

Referring to FIGS. 7 and 9B, the busbars 20a and 20b are arranged asymmetrically in the left and right sides at distances a and b from a center portion C of the rail 16.

Accordingly, the fixing brackets 27 for fixing the left busbar 20a and the right busbar 20b are fixed on the frames 10 with different lengths and shapes at left and right.

In the above-described parking apparatus, the hanger 19 has a structure to circulate and rotate by the main chains 12, and the collector 30 has a structure of being eccentrically arranged on the hanger 19. By asymmetrically arranging the locations of the busbars 20a and 20b at the left and right, during circulation and rotation of the hanger 19, the collector 30 may always be coupled to each of the busbars 20a and 20b regardless of whether the hanger 19 is located at the left or right with respect to the center portion C of the rail 16.

Furthermore, in the charging system according to the present invention, as the busbars 20a and 20b are disposed only in the linear sections at the left and right sides of the rail 16, not in the curved sections at the upper and lower sides, short-circuit or electric shock according to a derailment problem or foreign material accumulation that may occur in the curved section may be prevented in advance.

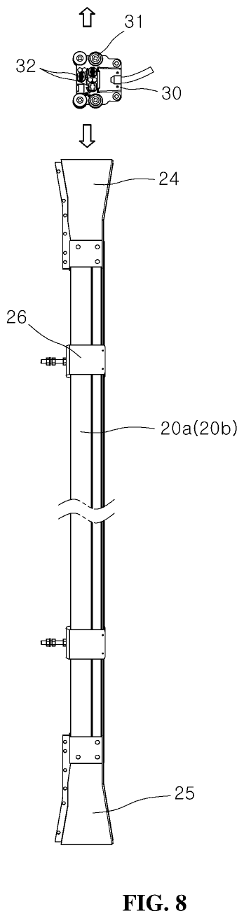

Referring to FIGS. 6B, 8, and 13B, an upper trumpet tube 24 having a wide entrance is coupled to an upper end of each of the busbars 20a and 20b and a lower trumpet tube 25 is coupled to a lower end thereof.

Accordingly, the collector 30 may safely enter each of the busbars 20a and 20b and smoothly slide therealong.

The collector 30 includes a guide roller 31 guided by the upper trumpet tube 24 and the lower trumpet tube 25, and a carbon brush 32 sliding on each of the busbars 20a and 20b.

Referring to FIGS. 13A and 13B, each of the busbars 20a and 20b includes a non-conductive casing 23 with one open side, and at least a pair of copper plates 22 arranged apart from each other in the casing 23 and through which power is supplied and slidably coupled with the carbon brush 32.

Referring to FIGS. 9A and 9C, the above configuration enables supply of electricity in parallel by dividing the copper plates 22 into several sections at a certain distance. In other words, the copper plates 22 are not present in a certain section so that an electricity feeding section is divided.

For example, as electricity is supplied in parallel by dividing the left busbar 20a into two or more feeding sections and the right busbar 20b into two or more feeding sections, the capacity of the busbars 20a and 20b may be reduced to be economical and safety may be increased.

The copper plates 22 of each of the busbars 20a and 20b are arranged in the casing 23 to have an electrical contact with the carbon brush 32, thereby solving a safety problem.

[List of Reference Numerals]

| | | | |
|---|---|---|---|
| 10 | frame | 11 | Motor |
| 12 | main chain | 13 | pallet holder |
| 14 | pallet | 15 | pivot shaft |
| 16 | rail | 16a | curved section (of a rail) |
| 16b | linear section (of a rail) | 17 | arm pipe |
| 18 | horizontal bars | 19 | hanger |
| 20a, 20b | busbars | 22 | copper plate |
| 23 | casing | 24 | upper trumpet tube |
| 25 | lower trumpet tube | 26 | fixing device |
| 27 | fixing brackets | 28 | distribution panel |
| 30 | collector | 31 | guide roller |
| 32 | carbon brush | 33 | bracket |
| 34 | charger | 35 | charging cable |
| 36 | electric vehicle | | |

What is claimed is:

1. A charging system of a vertical rotary type parking apparatus, comprising:
a pair of frames 10 arranged apart from each other;
a rail 16 having a track shape, fixed on each of the pair of frames 10, and comprising a curved section 16a disposed at each of upper and lower sides and a linear section 16b disposed at each of left and right sides;
a pair of main chains 12, each being movably coupled to the rail 16 and circulating and rotating by power of a motor 11;
a plurality of pallet holders 13, each having one end portion being fixed on each of the main chains 12 facing each other at regular intervals;
a hanger 19 comprising a pivot shaft 15 having both end portions pivotably connected to the plurality of pallet holders 13 facing each other, a pair of horizontal bars 18, each having a center portion fixed on both end portions of the pivot shaft 15, a pallet 14 on which a electric vehicle is loaded, and an arm pipe 17 connecting the pair of horizontal bars 18 to the pallet 14 so that the pallet 14 maintains a horizontal state;
a pair of busbars 20a and 20b, through each of which power is supplied, fixed on the frames 10 corresponding to the linear section 16b of the rail 16, and asymmetrically arranged in left and right sides with respect to a center portion of the rail 16;
a distribution panel 28 configured to supply power by connecting a power cable to each of the busbars 20a and 20b;
a collector 30 mounted on the horizontal bars 18 apart from the pivot shaft 15 by a certain distance, and sliding along the busbars 20a and 20b; and
a charger 34 mounted on the hanger 19 and receiving power from the collector 30 for charging electricity, wherein a electric vehicle 36 loaded on the pallet 14 is charged by the charger 34.

2. The charging system of a vertical rotary type parking apparatus of claim 1, wherein an upper trumpet tube 24 is provided on an upper end of each of the pair of busbars 20a and 20b and a lower trumpet tube 25 is provided on a lower end thereof, and
the collector 30 comprises a guide roller 31 guided by the upper trumpet tube 24 and the lower trumpet tube 25, and a carbon brush 32 sliding on each of the pair of busbars 20a and 20b.

3. The charging system of a vertical rotary type parking apparatus of claim 1, wherein each of the pair of busbars 20a and 20b comprises a non-conductive casing 23 having one open side, and at least a pair of copper plates 22 arranged apart from each other in the casing 23 and through which power is supplied and slidably coupled with the carbon brush 32, so that electricity is supplied in parallel.
